(19) United States
(12) Patent Application Publication
(10) Pub. No.: US 2026/0100047 A1
(43) Pub. Date: Apr. 9, 2026

(54) AI CAMERA SURVEILLANCE DEVICES AND METHODS FOR MULTI-SCENARIO APPLICATIONS

(71) Applicant: AIMATICS CO.,LTD, Seoul (KR)

(72) Inventors: Su Il LEE, Sejong-si (KR); Ji Won PARK, Seoul (KR); Jun Hyuk CHOI, Incheon (KR); Hwa Yeong LEE, Seoul (KR)

(73) Assignee: AIMATICS CO.,LTD, Seoul (KR)

(21) Appl. No.: 19/349,332

(22) Filed: Oct. 3, 2025

(30) Foreign Application Priority Data
Oct. 7, 2024 (KR) 10-2024-0135977

(51) Int. Cl. G06V 20/52; G06V 10/24; G06V 10/25; G06V 10/70; G06V 10/98; H04N 7/18

(52) U.S. Cl. CPC G06V 20/52; G06V 10/243; G06V 10/25; G06V 10/70; G06V 10/993; H04N 7/183

(57) ABSTRACT

An AI camera surveillance device includes: a detection region image receiving unit which receives a camera-dependent detection region image; a detection region image preprocessing unit which calculates a distortion correction coefficient for the camera-dependent detection region image and applies the distortion correction coefficient to the camera-dependent detection region image to generate a camera-independent detection region image; a region-of-interest setting unit which sets at least one region-of-interest (ROI) for the camera-independent detection region image; an alarm region setting unit which sets an alarm region by applying an artificial intelligence detection scenario model that monitors each of at least one region-of-interest (ROI) to process occurrence of a user-defined event and execution of a user-defined action; and an administrator-defined scenario execution unit which performs an administrator-defined scenario by detecting occurrence of a user-defined event and processing of a user-defined actions for a specific region-of-interest (ROI) through the artificial intelligence detection scenario model.

### CROSS-REFERENCE TO PRIOR APPLICATION

This Application claims priority to Korean Patent Application No. 10-2024-0135977 (filed on Oct. 7, 2024), which is all hereby incorporated by reference in its entirety.

### BACKGROUND

The present disclosure relates to artificial intelligence camera monitoring technology, and more particularly, artificial intelligence (AI) camera surveillance devices and methods for multi-scenario applications which may monitor blind spots of a vehicle.

Vehicles must accurately recognize traffic information in order to safely protect pedestrians walking on roads. Traffic information must be accurately transmitted to vehicles, and technologies are being developed to transmit traffic information to vehicles to prevent traffic accidents caused by vehicles.

Blind Spot Monitoring (BSM) technology corresponds to a blind spot detection system that detects blind spots through cameras or radar sensors installed at rear and sides of a vehicle and warns a driver.

Conventional blind spot detection systems have a problem in that the conventional blind spot detection systems can only confirm vehicle position information by simply signaling the vehicle position information, and cannot ensure safety from various types of safety accidents that may be caused by other vehicles. For example, very serious accidents occur when passengers are injured by being caught in a vehicle door while getting out before the vehicle comes to a complete stop, or when the vehicle starts while the passengers are caught in the door. Further, there are problems in that collision and contact accidents may occur due to various external hazardous factors around the vehicle, such as when there are obstacles near the door when passengers exit the vehicle, when motorcycles or bicycles are passing by, or when the vehicle moves forward or backward without knowing that there are people in front of or behind the vehicle.

In addition, images collected from cameras and radar sensors of the blind spot monitoring systems frequently exhibit phenomena where the size and shape of objects are distorted, such as barrel distortion and pincushion distortion, making it difficult to accurately detect vehicles or hazardous objects in blind spots and causing numerous unnecessary alarm sounds.

Therefore, to solve these problems, there is a need for blind spot detection system technology that can be applied to various hazardous scenarios by accurately detecting dangerous objects in blind spots through performing distortion correction on images collected from cameras.

Related Art: Korean Patent Registration No. 10-1478053 (December 24, 2024)

### SUMMARY

In view of the above, an embodiment of the present disclosure provides AI camera surveillance devices and methods for multi-scenario applications which may perform distortion correction by receiving images of a camera-dependent detection region and applying the received images to the camera-dependent detection region according to distortion correction coefficients. In view of the above, an embodiment of the present disclosure provides AI camera surveillance devices and methods for multi-scenario applications which set a region-of-interest (ROI) and perform monitoring thereof to execute actions according to events occurring in the region-of-interest (ROI).

In view of the above, an embodiment of the present disclosure provides AI camera surveillance devices and methods for multi-scenario applications which may perform administrator-defined scenarios based on an artificial intelligence detection scenario model.

Among embodiments, an AI camera surveillance device for multi-scenario applications includes: a detection region image receiving unit which receives a camera-dependent detection region image; a detection region image preprocessing unit which calculates a distortion correction coefficient for the camera-dependent detection region image and applies the distortion correction coefficient to the camera-dependent detection region image to generate a camera-independent detection region image; a region-of-interest setting unit which sets at least one region-of-interest (ROI) for the camera-independent detection region image; an alarm region setting unit which sets an alarm region by applying an artificial intelligence detection scenario model that monitors each of at least one region-of-interest (ROI) to process occurrence of a user-defined event and execution of a user-defined action; and an administrator-defined scenario execution unit which performs an administrator-defined scenario by detecting occurrence of a user-defined event and processing of a user-defined actions for a specific region-of-interest (ROI) through the artificial intelligence detection scenario model.

The detection region image preprocessing unit may periodically calculate a distortion correction coefficient and pre-calibrate spherical distortion and defect distortion of the camera-dependent detection region image based on the distortion correction coefficient.

The region-of-interest setting unit may set a specific region within the camera-independent detection region image and define a situation that may occur in the specific region or a situation that may affect the specific region as the user-defined event.

The region-of-interest setting unit may determine a detection purpose of a specific region by analyzing a correlation between main items in the user-defined event through an artificial intelligence transformer and provide a system recommended action according to a surveillance purpose to generate the user-defined action.

The region-of-interest setting unit may detect a controllable IoT device in the vicinity of a location of the camera-dependent detection region image and generate the system recommended action including a control command for the IoT device.

The alarm region setting unit may generate thread that perform surveillance monitoring independently for each of at least one region-of-interest (ROI) and set an execution priority of the thread based on a surveillance importance of each of the at least one region-of-interest (ROI). The administrator-defined scenario execution unit may record the camera-dependent detection region image from a moment at which the occurrence of the user-defined event is detected for the specific region-of-interest (ROI), and record the item-by-item processing contents of the user-defined action from a moment at which the processing of the user-defined action begins.

The detection region image preprocessing unit may estimate lens parameters including at least one of a radial distortion coefficient, a tangential distortion coefficient, a focal length, or a principal point.

The administrator-defined scenario execution unit may export anonymized safety events including a near-miss metric or a time-to-collision (TTC) metric for before-after evaluations.

Among embodiments, an AI camera surveillance method for multi-scenario applications performed by an AI camera surveillance device for multi-scenario applications includes: a detection region image receiving step of receiving a camera-dependent detection region; a detection region image preprocessing step of calculating a distortion correction coefficient for the camera-dependent detection region image and applying the distortion correction coefficient to the camera-dependent detection region image to generate a camera-independent detection region image; a region-of-interest (ROI) setting step of setting at least one region-of-interest (ROI) for the camera-independent detection region image; an alarm region setting step of setting an alarm region by applying an artificial intelligence detection scenario model that monitors each of at least one region-of-interest (ROI) to process occurrence of a user-defined event and execution of a user-defined action; and an administrator-defined scenario execution step of performing an administrator-defined scenario by detecting occurrence of a user-defined event and processing of a user-defined actions for a specific region-of-interest (ROI) through the artificial intelligence detection scenario model.

In some embodiments, the device estimates lens parameters (including, e.g., focal length, principal point, and radial/tangential distortion coefficients) and remaps pixels to generate a camera-independent detection region image; multiple regions of interest (ROIs) are monitored by concurrent processes prioritized by vulnerable road-user (VRU) proximity, approach angle, and object speed.

Certain embodiments compute quantitative safety metrics within ROIs (e.g., near-miss counts and time-to-collision, TTC) and export anonymized safety events to enable before-after evaluations.

The disclosed technology may have the following effects. However, since it is not meant that a specific embodiment should include all of the following effects or merely include the following effects, the scope of the disclosed technology is not to be construed as being limited thereby.

According to an embodiment of the present disclosure, AI camera surveillance devices and methods for multi-scenario applications may perform distortion correction by receiving images of a camera-dependent detection region and applying the received images to the camera-dependent detection region according to distortion correction coefficients.

According to an embodiment of the present disclosure, the AI camera surveillance devices and methods for multi-scenario applications set a region-of-interest (ROI) and perform monitoring thereof to execute actions according to events occurring in the region-of-interest (ROI).

According to an embodiment of the present disclosure, the AI camera surveillance devices and methods for multi-scenario applications may perform administrator-defined scenarios based on an artificial intelligence detection scenario model.

### BRIEF DESCRIPTION OF THE DRAWINGS

FIG. 1 is a diagram for describing a configuration of an AI camera surveillance device according to an embodiment of the present disclosure.

FIG. 2 is a diagram for describing the configuration of the AI camera surveillance device according to an embodiment of the present disclosure.

FIG. 3 is a flowchart for describing a functional configuration of an AI camera surveillance device according to an embodiment of the present disclosure.

FIG. 4 is a diagram for describing an embodiment of an AI camera surveillance device according to an embodiment of the present disclosure.

### DETAILED DESCRIPTION

A description of the present disclosure is merely an embodiment for a structural or functional description and the scope of the present disclosure should not be construed as being limited by an embodiment described in a text. That is, since the embodiment can be variously changed and have various forms, the scope of the present disclosure should be understood to include equivalents capable of realizing the technical spirit. Further, it should be understood that since a specific embodiment should include all objects or effects or include only the effect, the scope of the present disclosure is limited by the object or effect.

Meanwhile, meanings of terms described in the present application should be understood as follows.

The terms “first,” “second,”, and the like are used to differentiate a certain element from other elements, but the scope of should not be construed to be limited by the terms. For example, a first element may be referred to as second element, and similarly, the second element may be referred to as first element.

It should be understood that, when it is described that an element is “connected to” another element, the element may be directly connected to another element or a third element may be present therebetween. In contrast, it should be understood that, when it is described that an element is “directly connected to” another element, it is understood that no element is present between the element and another element. Meanwhile, other expressions describing the relationship of the elements, that is, expressions such as “between” and “directly between” or “adjacent to”and “directly adjacent to”should be similarly interpreted.

It is to be understood that the singular expression encompass a plurality of expressions unless the context clearly dictates otherwise and it should be understood that term “include” or “have” indicates that a feature, a number, a step, an operation, an element, a part or the combination thereof described in the specification is present, but does not exclude a possibility of presence or addition of one or more other features, numbers, steps, operations, elements, parts or combinations thereof, in advance.

In each step, reference numerals (e.g., a, b, c, etc.) are used for convenience of description, the reference numerals are not used to describe the order of the steps and unless otherwise stated, it may occur differently from the order specified. That is, the respective steps may be performed similarly to the specified order, performed substantially simultaneously, and performed in an opposite order.

The present disclosure can be implemented as a computer-readable code on a computer-readable recording medium and the computer-readable recording medium includes all types of recording devices for storing data that can be read by a computer system. Examples of the computer readable recording medium may include a ROM, a RAM, a CD-ROM, a magnetic tape, a floppy disk, an optical data storage device, and the like. Further, the computer readable recording media may be stored and executed as codes which may be distributed in the computer system connected through a network and read by a computer in a distribution method.

If it is not contrarily defined, all terms used herein have the same meanings as those generally understood by those skilled in the art. Terms which are defined in a generally used dictionary should be interpreted to have the same meaning as the meaning in the context of the related art, and are not interpreted as an ideal meaning or excessively formal meanings unless clearly defined in the present application.

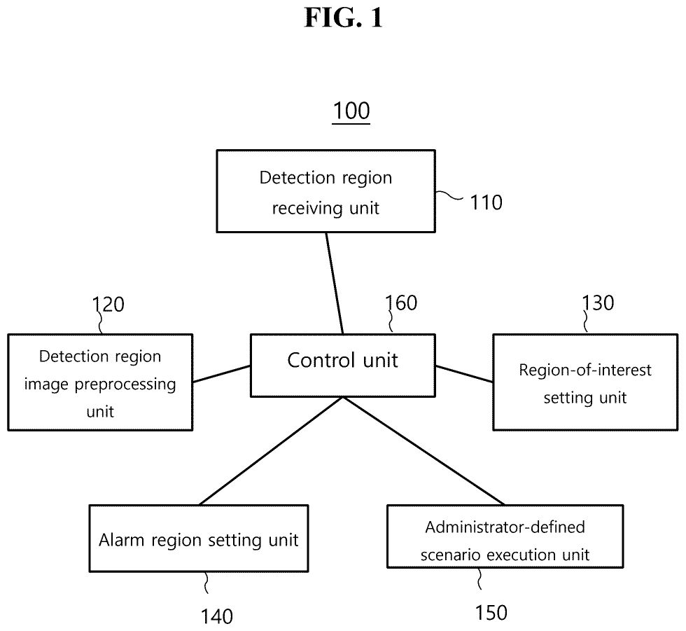

FIG. 1 is a diagram for describing a configuration of an AI camera surveillance device according to an embodiment of the present disclosure.

Referring to FIG. 1, an AI camera surveillance device 100 may include a detection region image receiving unit 110, a detection region image preprocessing unit 120, a region-of-interest setting unit 130, an alarm region setting unit 140, an administrator-defined scenario execution unit 150, and a control unit 160.

The AI camera surveillance device 100 does not particularly include all of the functional elements at the same time, and according to respective embodiments, some of the elements may be omitted, or the embodiment may also be implemented to selectively include some or all of the elements. Further, the AI camera surveillance device 100 may be implemented as an independent module that selectively includes some of the elements, and may perform an AI camera surveillance method for multi-scenario applications according to the present disclosure through an interaction between the respective modules. Hereinafter, an operation of each element will be described in detail.

The detection region image receiving unit 110 may receive a camera-dependent detection region image. Here, the camera-dependent detection region image may correspond to an image captured by an image capturing device such as a camera, etc., and is not necessarily limited thereto, but may correspond to an image collected according to physical characteristics of the camera such as a position, an angle, and lens characteristics of the camera. The detection region image receiving unit 110 may receive an image according to the position, angle, and lens characteristics of the camera and store the image in a database (not illustrated in FIG. 1).

The detection region image preprocessing unit 120 calculates a distortion correction coefficient for a camera-dependent detection region image and applies the distortion correction coefficient to the camera-dependent detection region image to generate a camera-independent detection region image. Here, the detection region image preprocessing unit 120 may detect a distortion pattern from the camera-dependent detection region image and calculate the distortion correction coefficient according to the distortion pattern. For example, the detection region image preprocessing unit 120 may detect distortion patterns such as barrel distortion, pincushion distortion, and shear distortion from the camera-dependent detection region image. Here, the barrel distortion may correspond to a phenomenon in which a center of an image is expanded and edges are contracted. The pincushion distortion may correspond to distortion in which the center is contracted and the edges are expanded, and the shear distortion may correspond to a phenomenon in which the shape of an image is translated or rotated such that an original rectangular structure is distorted. The detection region image preprocessing unit 120 is not particularly limited thereto, and may identify various distortions occurring according to physical characteristics of the camera including a lens type, a viewing angle, and a focal length of the camera, and calculate distortion correction coefficients according to the distortions.

In an embodiment, the detection region image preprocessing unit 120 may detect the barrel distortion from the camera-dependent detection region image from a camera including a wide-angle lens, and calculate a distortion correction coefficient for correcting the barrel distortion. Furthermore, the detection region image preprocessing unit 120 may detect the pincushion distortion from a camera-dependent detection region image captured by a camera including a telephoto lens and derive a distortion correction coefficient according to the pincushion distortion, and is not particularly limited thereto, but may calculate a distortion correction coefficient according to a distortion pattern detected from the camera-dependent detection region image.

In an embodiment, the detection region image preprocessing unit 120 may correct pixels of the camera-dependent detection region image by applying the distortion correction coefficient to the camera-dependent detection region image. Here, the detection region image preprocessing unit 120 may convert distorted coordinates of each pixel of the camera-dependent detection region image into coordinates corrected by the distortion correction coefficient. In an embodiment, the detection region image preprocessing unit 120 may perform correction for the pixels of the camera-dependent detection region image through coordinate remapping. Here, the detection region image preprocessing unit 120 may correct the pixels of the camera-dependent detection region image by transforming a position of each pixel through the coordinate remapping and performing interpolation. For example, the detection region image preprocessing unit 120 may maintain image quality and minimize discontinuity between pixels and loss due to distortion by performing interpolations such as bilinear interpolation and cubic interpolation.

In an embodiment, the detection region image preprocessing unit 120 may periodically calculate a distortion correction coefficient and may pre-calibrate spherical distortion and defect distortion of the camera-dependent detection region image based on the distortion correction coefficient. Here, the spherical distortion may include the barrel distortion, the pincushion distortion, and the shear distortion. Further, the defect distortion may correspond to a phenomenon where image distortion or quality deterioration occurs due to a specific defect which occurs in the camera image, for example, distortion caused by a defect and physical damage in the camera lens. The detection region image preprocessing unit 120 may periodically calculate the distortion correction coefficient in order to detect a change in camera environment over time. For example, the detection region image preprocessing unit 120 may update the distortion correction coefficient according to changes in physical characteristics of the camera due to external factors such as dust and environmental changes such as temperature. Here, the detection region image preprocessing unit 120 may recalculate the distortion correction coefficient according to a period set by an administrator, but is not particularly limited thereto and may update the distortion correction coefficient upon detecting the change in camera environment.

In addition, the detection region image preprocessing unit 120 may update the distortion correction coefficient based on the changes in physical characteristics of the camera in real time by pre-calibrating the spherical distortion and defect distortion of the camera-dependent detection region image based on the distortion correction coefficient. Here, the detection region image preprocessing unit 120 may re-adjust the distortion correction coefficient for correcting the spherical distortion according to a lens shape of the camera. In addition, the detection region image preprocessing unit 120 may adjust the distortion correction coefficient for detecting defects in the camera lens, etc., and performing correction for a defective portion based on a specific algorithm. For example, the detection region image preprocessing unit 120 may recognize defects such as lens unevenness, pixel defects and lens contamination based on a defect detection algorithm and adjust the distortion correction coefficient.

In an embodiment, the detection region image preprocessing unit 120 may update the distortion correction coefficient in real time by performing pre-calibration utilizing a chessboard pattern. The detection region image preprocessing unit 120 is not particularly limited thereto and may update the distortion correction coefficients by estimating internal parameters such as a focal length and principal point coordinates through parameter estimation techniques and performing inverse transformation of camera-dependent detection region images. Further, the detection region image preprocessing unit 120 may correct distortion occurring in the camera-dependent detection region image by performing pre-calibration based on a software program including OpenCV.

By way of example and not limitation, lens parameters may include a focal length, a principal point, and one or more radial or tangential distortion coefficients; coordinate remapping with interpolation (e.g., bilinear or bicubic) may be used to obtain a camera-independent detection region image. Distortion parameters may be periodically re-estimated or updated in response to environmental triggers (e.g., temperature drift, vibration, or lens contamination).

The region-of-interest setting unit 130 may set at least one region-of-interest (ROI) for a camera-independent detection region image. For example, the region-of-interest setting unit 130 may detect a specific event occurring from the camera-independent detection region image and designate an event occurrence region as a region-of-interest (ROI). Here, the specific event may correspond to movement of a person, vehicle movement, and occurrence of a hazardous object, but is not particularly limited thereto. The region-of-interest setting unit 130 sets coordinates and a size of a specific event occurrence region in pixel units to set the event occurrence region as the region-of-interest (ROI). Further, the region-of-interest setting unit 130 may set a plurality of regions of interest as needed, and independently perform analysis and monitoring for each region-of-interest (ROI).

In an embodiment, the region-of-interest setting unit 130 may set a specific region within the camera-independent detection region image and define a situation that may occur in the specific region or a situation that may affect the specific region as a user-defined event. Here, the situation that may occur in the specific region may correspond to movement of an object occurring within the region-of-interest (ROI) and may include, for example, vehicle parking. Further, the situation that may affect the specific region may correspond to movement in a neighboring region that affects the region-of-interest (ROI) and may correspond to, for example, a moving vehicle. The user-defined event may correspond to performing a task predefined by the administrator in response to a specific situation which occurs in an image. The region-of-interest setting unit 130 may define, according to occurrence of a specific situation in the camera-independent detection region image, the situation as the user-defined event, and perform an action according to occurrence of the user-defined event.

In an embodiment, the region-of-interest setting unit 130 may derive the user-defined event from the camera-independent detection region image according to an event trigger condition preset by the administrator. Here, the event trigger condition may correspond to a condition for detecting a situation in which an event occur, and may include, for example, an appearance of a specific object, movement detection, and an action of approaching a specific region. In an embodiment, the region-of-interest setting unit 130 may detect a specific action occurring within the region-of-interest (ROI) based on a specific algorithm and determine the action as the user-defined event. For example, the region-of-interest setting unit 130 may detect a specific action within the region-of-interest (ROI) by performing object recognition, movement detection, and pattern analysis on the camera-independent detection region image based on an image analysis algorithm, and derive a user-defined event according to the specific action.

In an embodiment, the region-of-interest setting unit 130 determines a detection purpose of a specific region by analyzing a correlation between main items in the user-defined event through an artificial intelligence transformer and provides a system recommended action according to a surveillance purpose to generate a user-defined action. Here, the artificial intelligence transformer may correspond to models used in various artificial intelligence fields such as natural language processing (NLP) and a computer vision. Further, the system recommended action may correspond to a response measure for each user-defined event derived based on the artificial intelligence transformer, and may include, for example, response measures including generating a warning alarm, video recording, and sending a notification. For example, the region-of-interest setting unit 130 may provide a system recommended action according to detection purposes including intrusion detection, illegal parking detection, and fire detection.

In an embodiment, the region-of-interest setting unit 130 may determine a detection purpose by performing correlation analysis between main items including an event, an object, and a condition of the user-defined event based on the artificial intelligence transformer. Here, the correlation analysis may correspond to analyzing the user-defined event based on a correlation between main items. That is, the region-of-interest setting unit 130 may predict an occurrence probability of a specific user-defined event through the correlation analysis between the main items and provide a response measure for the user-defined event. The region-of-interest setting unit 130 may identify an abnormal situation occurring in the camera-independent detection region image through the correlation analysis, and for example, when a person is detected from a specific region during a specific time zone, the detection purpose may be set to intrusion prevention. In another embodiment, the region-of-interest setting unit 130 may detect illegal parking through correlation analysis of vehicles and time zones during monitoring of the region-of-interest (ROI).

In an embodiment, the region-of-interest setting unit 130 may determine a user-defined action for a user-defined event occurring in a specific region. Here, the user-defined action may correspond to a response measure set to be automatically executed when a specific event trigger condition is satisfied for a situation identified by the artificial intelligence transformer. For example, the region-of-interest setting unit 130 may set a user-defined action to immediately provide an alarm when movement of a person is detected during a specific time zone. Further, the region-of-interest setting unit 130 may configure a user-defined action to automatically open an entrance door when a specific vehicle is recognized, and is not particularly limited thereto, but may determine a user-defined action to notify the administrator while uploading a CCTV image to a cloud when an intrusion behavior is detected during surveillance. That is, the region-of-interest setting unit 130 may determine a user-defined action to perform an immediate response measure when a specific user-defined event occurs.

In an embodiment, the region-of-interest setting unit 130 may detect a controllable IoT device in the vicinity of a position of the camera-dependent detection region image and generate a system recommended action including a control command for the IoT device. Here, the IoT device may include terminals such as a CCTV, a door lock, and an alarm system. The region-of-interest setting unit 130 may be connected to the IoT device by detecting the IoT device based on wireless networks such as Wi-Fi, Bluetooth, Zigbee, and Z-Wave and performing an authentication procedure. Here, when the region-of-interest setting unit 130 is connected to the IoT device, the region-of-interest setting unit 130 may perform control of the IoT device according to the system recommended action. For example, when the region-of-interest setting unit 130 detects the movement of the person from the region-of-interest (ROI) during a specific time zone, the region-of-interest setting unit 130 may be connected to IoT devices such as lighting sensors and smart door locks to generate system recommended actions such as a lighting control and an alarm system.

The alarm region setting unit 140 may set an alarm region by applying an artificial intelligence detection scenario model that monitors each of at least one region-of-interest (ROI) to process occurrence of the user-defined events and execution of the user-defined actions. Here, the artificial intelligence detection scenario model may correspond to an AI-based automation system that analyzes a camera-independent detection region image to detect a specific user-defined event and automatically set a resulting action, and for example, may perform roles such as abnormal behavior detection and user-defined event prediction through object tracking. In an embodiment, the alarm region setting unit 140 may designate a region-of-interest (ROI) in which the alarm needs to be generated in a specific situation as the alarm region. Here, the alarm region setting unit 140 may monitor a specific alarm region to detect unauthorized intrusion, temperature abnormalities, and completion of specific tasks in the corresponding alarm region, and perform actions such as alarms and notifications.

In an embodiment, the alarm region setting unit 140 may generate threads that perform surveillance monitoring independently for each of at least one region-of-interest (ROI) and set an execution priority of the threads based on a surveillance importance of each of the at least one region-of-interest (ROI). Here, the threads may correspond to units for processing a plurality of user-defined events in parallel. The alarm region setting unit 140 may set the execution priority of each thread by assigning the surveillance importance according to the position of each region-of-interest (ROI). For example, when the alarm region setting unit 140 monitors a region-of-interest (ROI) containing valuables, the alarm region setting unit 140 may set a high surveillance importance for the corresponding region-of-interest (ROI) and process the corresponding region-of-interest (ROI) with priority.

Further, the alarm region setting unit 140 may set the surveillance importance for each thread by assigning the surveillance importance based on human casualties. For example, the alarm region setting unit 140 may assign the high surveillance importance to a region-of-interest (ROI) where multiple human casualties occur or a probability of human casualties is high, and is not particularly limited thereto, and may readjust, when an abnormal behavior or a dangerous situation occurs in real time in a specific region-of-interest (ROI), execution priority by immediately adjusting the surveillance importance of the corresponding region-of-interest (ROI). In some embodiments, the system prioritizes region-of-interest (ROI) monitoring via concurrent processes based on a safety-importance score that accounts for Vulnerable road-user (VRU) proximity, approach vector, object speed, and historical risk. The device computes region-of-interest (ROI)-level near-miss and time-to-collision (TTC) metrics and exports anonymized events (with timestamps and identifiers) to support standardized before-after evaluations at fleet or municipal scale.

The administrator-defined scenario execution unit 150 may perform an administrator-defined scenario by detecting the occurrence of the user-defined events and the processing of the user-defined actions for the specific region-of-interest (ROI) through the artificial intelligence detection scenario model. Here, the administrator-defined scenario may correspond to a user-defined action process performed according to a specific user-defined event, and may include, for example, various scenarios such as a security scenario, a fire detection scenario, and a smart factory scenario. For example, the administrator-defined scenario execution unit 150 may perform a fire detection scenario that controls IoT devices such as a sprinkler when detecting a fire-related user-defined event for a specific region-of-interest (ROI). In an embodiment, the administrator-defined scenario execution unit 150 may perform, when a person is detected in a specific alarm region, a security scenario that provides an alarm notification to the administrator and controls opening and closing of a smart door in the corresponding region-of-interest (ROI). In an embodiment, the administrator-defined scenario execution unit 150 may record the camera-dependent detection region image from a moment at which occurrence of the user-defined event is detected for the specific region-of-interest (ROI), and record item-by-item processing contents of the user-defined action from a moment at which processing of the user-defined action begins. For example, the administrator-defined scenario execution unit 150 may record the camera-dependent detection region image and the item-by-item processing contents of the user-defined action, and check whether the administrator-defined scenario is executed normally. Further, the administrator-defined scenario execution unit 150 may store the recorded camera-dependent detection region image and item-by-item processing contents of the user-defined action in a database and utilize the stored camera-dependent detection region image and item-by-item processing contents as legal evidence data.

In an embodiment, the administrator-defined scenario execution unit 150 may mark specific time points for the camera-dependent detection region image and the item-by-item processing contents of the user-defined action to enable searching thereof. For example, the administrator-defined scenario execution unit 150 marks a specific user-defined event occurrence time point for the camera-dependent detection region image, thereby confirming an image at the corresponding user-defined event occurrence time point. Further, the administrator-defined scenario execution unit 150 may mark specific time points when item-by-item processing contents of the user-defined action are performed and enable confirmation of images when the user-defined action is performed.

In an embodiment, the administrator-defined scenario execution unit 150 may provide processing details of user-defined events for a specific region-of-interest (ROI) and user-defined actions for the corresponding user-defined events to the artificial intelligence transformer and the artificial intelligence detection scenario model. Through this, the administrator-defined scenario execution unit 150 may generate a real-time feedback loop that trains the artificial intelligence transformer and the artificial intelligence detection scenario model for the user-defined events and the user-defined actions. That is, the administrator-defined scenario execution unit 150 may continuously train the artificial intelligence transformer and the artificial intelligence detection scenario model to generate, when a new user-defined event occurs, a user-defined action for the new user-defined event.

The control unit 160 may control overall operations of the AI camera surveillance device 100, and manage control flows or data flows among the detection region image receiving unit 110, the detection region image preprocessing unit 120, the region-of-interest setting unit 130, the alarm region setting unit 140, and the administrator-defined scenario execution unit 150.

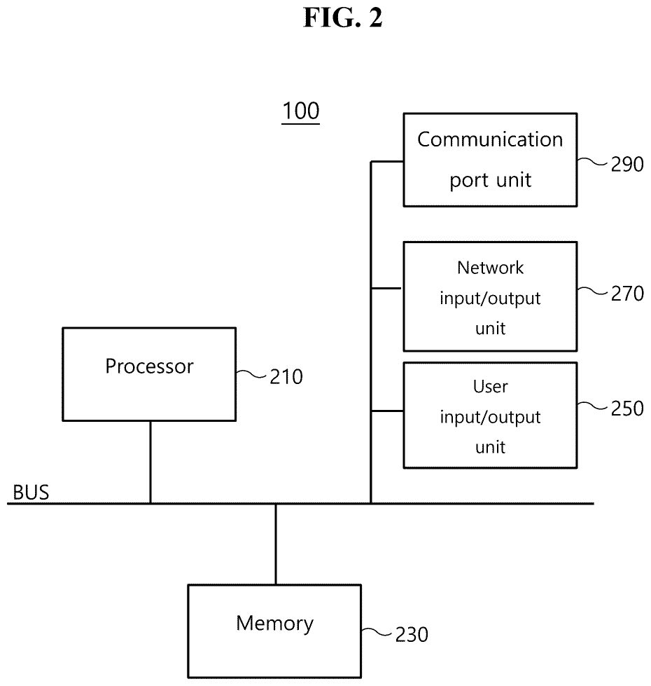

FIG. 2 is a diagram for describing the configuration of the AI camera surveillance device according to an embodiment of the present disclosure.

Referring to FIG. 2, the AI camera surveillance device 100 may include a processor 210, a memory 230, a user input/output unit 250, a network input/output unit 270, and a communication port unit 290.

The processor 210 may execute an AI camera surveillance service procedure according to an embodiment of the present disclosure, and manage the memory 230 that is read or written in this process, and schedule a synchronization time between a volatile memory and a non-volatile memory. The processor 210 may control the overall operations of the AI camera surveillance device 100 and is electrically connected to the memory 230, the user input/output unit 250, the network input/output unit 270, and the communication port unit 290 to control data flows therebetween. The processor 210 may be implemented as a Central Processing Unit (CPU) or a Graphics Processing Unit (GPU) of the AI camera surveillance device 100.

The memory 230 may include an auxiliary storage device implemented as the non-volatile memory such as a solid state disk (SSD) or a hard disk drive (HDD) and used to store all data required for the AI camera surveillance device 100, and may include a main storage device implemented as the volatile memory such as a Random Access Memory (RAM). In addition, the memory 230 may store a set of instructions that are executed by the electrically connected processor 210 to execute the AI camera surveillance method according to the present disclosure. The user input/output unit 250 may include an environment for receiving a user input and an environment for outputting specific information to a user, and include, for example, an input device including an adapter such as a touch pad, a touch screen, an on-screen keyboard, or a pointing device, and an output device including an adapter such as a monitor or a touch screen. In an embodiment, the user input/output unit 250 may correspond to a computing device connected through a remote connection, and in such a case, the AI camera surveillance device 100 may be performed as an independent server.

The network input/output unit 270 provides a communication environment for connection to a user terminal through the network, and may include, for example, an adapter for communication such as Local Area Network (LAN), Metropolitan Area Network (MAN), Wide Area Network (WAN), and Value Added Network (VAN). Further, the network input/output unit 270 may be implemented to provide short-range communication functions such as WiFi and Bluetooth or wireless communication functions of 4G or higher for wireless transmission of training data.

The communication port unit 290 may be implemented as a port mapping table that performs data routing in a process of transmitting and receiving data through a network. Here, the communication port unit 290 may distinguish communication sessions between the image acquisition unit 110 and the server by allocating a unique source port to each image acquisition unit 110, thereby preventing data collisions in the data transmission and reception process.

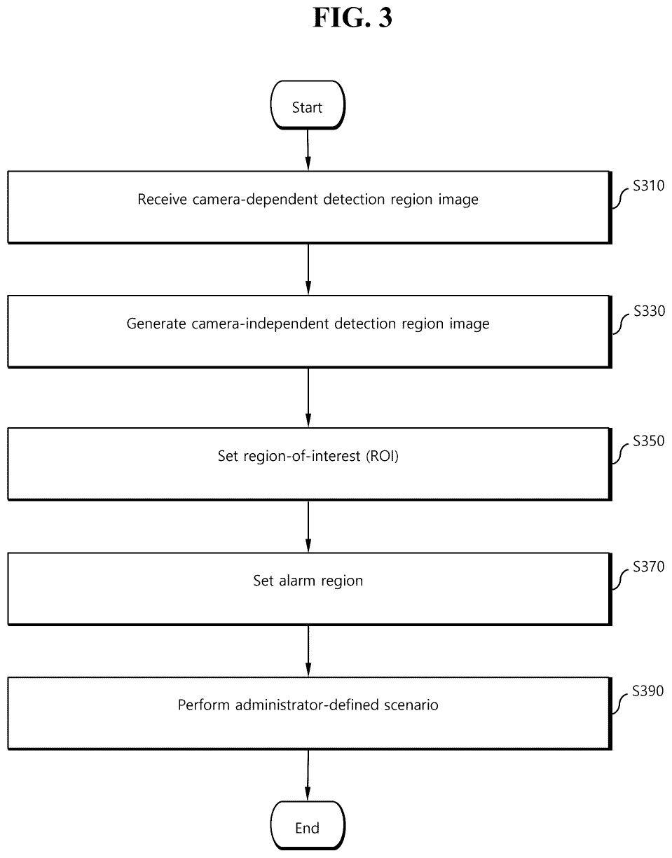

FIG. 3 is a flowchart for describing a functional configuration of an AI camera surveillance device according to an embodiment of the present disclosure.

Referring to FIG. 3, the AI camera surveillance device 100 may receive a camera-dependent detection region image based on a detection region image receiving unit 110 (step S310). Here, the AI camera surveillance device 100 may receive images according to physical characteristics of a camera and perform classification according to a position, an angle and lens characteristics of the camera and store the position, angle and lens characteristics of the camera in a database. The AI camera surveillance device 100 calculates a distortion correction coefficient for a camera-dependent detection region image through a detection region image preprocessing unit 120 and applies the distortion correction coefficient to the camera-dependent detection region image to generate a camera-independent detection region image (step S330).

The AI camera surveillance device 100 may set at least one region-of-interest (ROI) for the camera-independent detection region image through a region-of-interest setting unit 130 (step S350). Here, the AI camera surveillance device 100 may set a specific region within the camera-independent detection region image and define a situation that may occur in the specific region or a situation that may affect the specific region as a user-defined event.

The AI camera surveillance device 100 may set an alarm region by applying an artificial intelligence detection scenario model that monitors each of at least one region-of-interest (ROI) to process occurrence of a user-defined event and execution of a user-defined action through an alarm region setting unit 140 (step S370). The AI camera surveillance device 100 may perform an administrator-defined scenario by detecting the occurrence of the user-defined event and the processing of the user-defined action for the specific region-of-interest (ROI) through an artificial intelligence detection scenario model based on an administrator-defined scenario execution unit 150 (step S390).

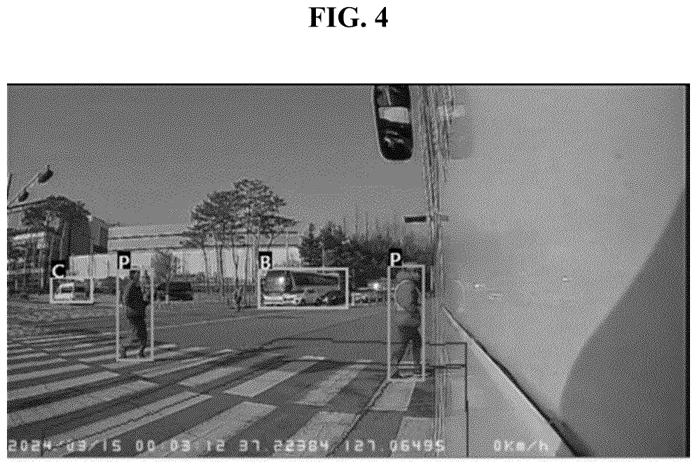

FIG. 4 is a diagram for describing an embodiment of an AI camera surveillance device according to an embodiment of the present disclosure.

In FIG. 4, the AI camera surveillance device 100 may identify at least one object from the camera-independent detection region image and perform classification for each object. For example, the AI camera surveillance device 100 may classify an object identified in the camera-independent detection region image as a vehicle, a bus, and a person. The AI camera surveillance device 100 may generate a bounding box for each object identified in the camera-independent detection region image. Here, the AI camera surveillance device 100 may indicate, based on coordinates and a size of each object, an object position in the camera-independent detection region image by generating the bounding box surrounding each object.

In an embodiment, the AI surveillance device 100 may set an alarm region for the camera-independent detection region image based on the artificial intelligence detection scenario model. For example, the AI surveillance device 100 may set the alarm region according to movement paths of objects corresponding to the vehicle and the bus, and detect an object corresponding to a person approaching the alarm region. Here, the AI camera surveillance device 100 may execute an administrator-defined scenario corresponding to a safety scenario through the AI detection scenario model in the camera-independent detection region image. For example, the AI camera surveillance device 100 may detect the person approaching the movement paths of the vehicle and the bus, and generate alarm notification.

The present disclosure has been described with reference to the preferred embodiments of the present disclosure, but those skilled in the art will understand that the present disclosure can be variously modified and changed without departing from the spirit and the scope of the present disclosure which are defined in the appended claims.

### DETAILED DESCRIPTION OF MAIN ELEMENT

100: AI camera surveillance device
110: Detection region image receiving unit
120: Detection region image preprocessing unit
130: Region-of-interest setting unit
140: Alarm region setting unit
150: Administrator-defined scenario execution unit
160: Control unit
210: Processor
230: Memory
250: User input/output unit
270: Network input/output unit
290: Communication port unit

1. An AI camera surveillance device comprising:
a detection region image receiving unit which receives a camera-dependent detection region image;
a detection region image preprocessing unit which calculates a distortion correction coefficient for the camera-dependent detection region image and applies the distortion correction coefficient to the camera-dependent detection region image to generate a camera-independent detection region image;
a region-of-interest setting unit which sets at least one region-of-interest (ROI) for the camera-independent detection region image;
an alarm region setting unit which sets an alarm region by applying an artificial intelligence detection scenario model that monitors each of at least one region-of-interest (ROI) to process occurrence of a user-defined event and execution of a user-defined action; and
an administrator-defined scenario execution unit which performs an administrator-defined scenario by detecting occurrence of a user-defined event and processing of a user-defined actions for a specific region-of-interest (ROI) through the artificial intelligence detection scenario model.

2. The AI camera surveillance device of claim 1, wherein the detection region image preprocessing unit periodically calculates a distortion correction coefficient and pre-calibrates spherical distortion and defect distortion of the camera-dependent detection region image based on the distortion correction coefficient.

3. The AI camera surveillance device of claim 1, wherein the region-of-interest setting unit sets a specific region within the camera-independent detection region image and defines a situation that may occur in the specific region or a situation that may affect the specific region as the user-defined event.

4. The AI camera surveillance device of claim 3, wherein the region-of-interest setting unit determines a detection purpose of a specific region by analyzing a correlation between main items in the user-defined event through an artificial intelligence transformer and provides a system recommended action according to a surveillance purpose to generate the user-defined action.

5. The AI camera surveillance device of claim 4, wherein the region-of-interest setting unit detects a controllable IoT device in the vicinity of a position of the camera-dependent detection region image and generates the system recommended action including a control command for the IoT device.

6. The AI camera surveillance device of claim 1, wherein the alarm region setting unit generates threads that perform surveillance monitoring independently for each of at least one region-of-interest (ROI) and sets an execution priority of the thread based on a surveillance importance of each of the at least one region-of-interest (ROI).

7. The AI camera surveillance device of claim 1, wherein the administrator-defined scenario execution unit records the camera-dependent detection region image from a moment at which the occurrence of the user-defined event is detected for the specific region-of-interest (ROI), and records the item-by-item processing contents of the user-defined action from a moment at which the processing of the user-defined action begins.

8. The device of claim 1, wherein the detection region image preprocessing unit estimates lens parameters including at least one of a radial distortion coefficient, a tangential distortion coefficient, a focal length, or a principal point.

9. The device of claim 1, wherein the administrator-defined scenario execution unit exports anonymized safety events including a near-miss metric or a time-to-collision (TTC) metric for before-after evaluations.

10. An AI camera surveillance method for multi-scenario applications performed by an AI camera surveillance device for multi-scenario applications, comprising:
a detection region image receiving step of receiving a camera-dependent detection region;
a detection region image preprocessing step of calculating a distortion correction coefficient for the camera-dependent detection region image and applying the distortion correction coefficient to the camera-dependent detection region image to generate a camera-independent detection region image;
a region-of-interest (ROI) setting step of setting at least one region-of-interest (ROI) for the camera-independent detection region image;
an alarm region setting step of setting an alarm region by applying an artificial intelligence detection scenario model that monitors each of at least one region-of-interest (ROI) to process occurrence of a user-defined event and execution of a user-defined action; and
an administrator-defined scenario execution step of performing an administrator-defined scenario by detecting occurrence of a user-defined event and processing of a user-defined actions for a specific region-of-interest (ROI) through the artificial intelligence detection scenario model.
